(19) United States
(12) Patent Application Publication
(10) Pub. No.: US 2026/0086963 A1
(43) Pub. Date: Mar. 26, 2026

(54) SYSTEMS AND METHODS FOR INTEGER-TO-FLOATING-POINT DATA TRANSFERS

(71) Applicant: Advanced Micro Devices, Inc., Santa Clara, CA (US)

(72) Inventors: Erik Swanson, Fort Collins, CO (US); Vincent Chuan-Ming Wang, Fort Collins, CO (US); Eric Dixon, Fort Collins, CO (US); Michael Estlick, Fort Collins, CO (US)

(73) Assignee: Advanced Micro Devices, Inc., Santa Clara, CA (US)

(21) Appl. No.: 18/896,508

(22) Filed: Sep. 25, 2024

(51) Int. Cl. G06F 13/20

(52) U.S. Cl. CPC G06F 13/20; G06F 2213/40

(57) ABSTRACT

A disclosed method for integer-to-floating-point data transfers includes intercepting, by a scheduler of a register file, a unit of register data from an external computing resource. The method also includes sorting, by the scheduler, the unit of register data into a first-in, first-out queue. Additionally, the method includes selecting, by the scheduler, a port of the register file based on a review of existing data pipelines to the register file. Furthermore, the method includes injecting, by the scheduler, the unit of register data into a data pipeline of the selected port, wherein the unit of register data is held in the first-in, first-out queue until previous register data is processed. Various other methods, devices, and systems are also disclosed.

### BACKGROUND

Registers can store various types of data that can then be easily and quickly accessed by a computing processor, often a central processing unit (CPU). For example, integer data registers can store numerical integer data or addresses and process operations acting on such data. Other examples of registers, such as floating-point registers, can store and process other types of complex data or multiple types of data. A register file, such as a physical register file, can represent a collection of registers used by a CPU, which can read values from the register file and perform operations on those values. Furthermore, a register file can include ports for loading data, ports for reading data from the register file, ports for writing data to the register file, mixed-use ports, and/or other ports for input or output. In some computer architectures, data can also be passed between registers or between external computing components and the register file, such as via a bus or data pipeline. The present disclosure identifies and addresses a need for systems and methods for integer-to-floating-point data transfers.

### BRIEF DESCRIPTION OF THE DRAWINGS

The accompanying drawings illustrate a number of example implementations and are a part of the specification. Together with the following description, these drawings demonstrate and explain various principles of the present disclosure.

FIG. 1 is a flow diagram of an example method for integer-to-floating-point data transfers.

FIG. 2 is a block diagram of an example system for integer-to-floating-point data transfers.

FIGS. 3A-3B are block diagrams of an exemplary first-in, first-out queue.

FIG. 4 illustrates an exemplary selection of a preferred port for exemplary register data.

FIG. 5 illustrates an exemplary selection of an alternate port for exemplary register data.

FIG. 6 illustrates an exemplary injection of register data into an exemplary data pipeline for a preferred port.

FIG. 7 illustrates an exemplary injection of exemplary register data into an exemplary data pipeline using multiplexing.

FIG. 8 is a block diagram of an exemplary system architecture with multiple exemplary computing resources sharing an exemplary register file.

FIG. 9 is a block diagram of an exemplary computing device architecture for implementing integer-to-floating-point data transfers.

Throughout the drawings, identical reference characters and descriptions indicate similar, but not necessarily identical, elements. While the example implementations described herein are susceptible to various modifications and alternative forms, specific implementations have been shown by way of example in the drawings and will be described in detail herein. However, the example implementations described herein are not intended to be limited to the particular forms disclosed. Rather, the present disclosure covers all modifications, equivalents, and alternatives falling within the scope of the appended claims.

### DETAILED DESCRIPTION OF EXEMPLARY IMPLEMENTATIONS

The present disclosure is generally directed to systems and methods for integer-to-floating-point data transfers. As described below, by monitoring and reviewing possible data collisions at a set of ports, a scheduler can evaluate register data transactions to manage incoming data from external components to a register file. For example, data from one register can be transferred to a different register, such as for integer-to-floating-point transfers, which can then format the data to comply with the destination register. In this example, the external components often do not share a scheduler with the register, so the register may need to be informed that the data transaction is incoming.

Because external resources like integer-to-floating-point transfers typically do not share schedulers, a physical register file may need dedicated resources, such as write ports, to directly write unexpected incoming data transfers to the file. However, write ports are expensive to implement, and the need for additional ports can increase with additional external resources in more complex systems. In some implementations, a write port can be temporarily blocked from other data traffic to ensure the integer-to-floating-point transfer is prioritized. However, blocking a port to insert the register data could hold up other data transactions for an extended period of time. Thus, a mechanism to stall data transactions or inject data into a data pipeline is needed to manage incoming data for register files.

In some implementations, the disclosed method monitors ports, such as load ports, of a register file. To control incoming data from external computing resources, the method first intercepts the incoming register data. In a non-limiting example, the method can sort incoming data into a first-in, first-out (FIFO) queue. By monitoring and sorting transaction data in a FIFO order, a scheduler can take several clock cycles to review existing data pipelines and attempt to find one to inject the next data transfer. In a non-limiting example, the method can prioritize a specific write port or data pipeline and then check additional pipelines if the preferred one is not available. If a preferred port and pipeline is immediately available, the next data transaction can be injected to that pipeline. In one implementation, the method can continue to look for an available port while the FIFO queue is not full in subsequent clock cycles. In this implementation, the scheduler can track the length of the FIFO queue, based on the longest latency of the preferred pipeline, to ensure that a data transfer does not time out and that the FIFO queue does not overfill. In non-limiting examples, the term “latency” refers to the time taken to execute an instruction. In other words, the length of the FIFO queue can be set according to the longest amount of time that the preferred pipeline takes to execute a data transaction. The disclosed method can then select an alternate port and pipeline that is available if the preferred write port continues to be used and remains unavailable.

However, all ports may be utilized and remain unavailable as the FIFO queue is filled. Subsequently, the scheduler can inject the next data transaction into the preferred pipeline by bypassing other transactions. By pausing the data flow of the preferred pipeline, the disclosed method can ensure the data transfer is completed without potentially losing additional data transactions. In some implementations, the injected data can instead be multiplexed with existing data in the pipeline to deliver both to the register file. In other words, the scheduler can review all potential write ports of a physical register file, determine if there are any available ports, and forcibly inject a data transaction to a preferred port if no ports are opportunistically available.

Furthermore, the method can implement integer-to-floating-point port sharing by intercepting data from load ports for better resource allocation. By monitoring load ports in particular, the method can detect when a transaction is occurring early enough to determine whether there will be a collision if data from the FIFO queue is injected, thereby ensuring enough advanced warning to avoid the collision. Thus, the disclosed systems and methods use opportunistic port sharing to control integer-to-floating-point data transfers from external resources.

As will be described in greater detail below, the present disclosure describes various systems and methods for integer-to-floating-point data transfers. In one implementation, a computer-implemented method for integer-to-floating-point data transfers includes intercepting, by a scheduler of a register file, a unit of register data from an external computing resource. This method also includes sorting, by the scheduler, the unit of register data into a first-in, first-out (FIFO) queue. Additionally, this method includes selecting, by the scheduler, a port of the register file based on a review of existing data pipelines to the register file. Furthermore, this method includes injecting, by the scheduler, the unit of register data into a data pipeline of the selected port, wherein the unit of register data is held in the FIFO queue until previous register data is processed.

In one example, the register file includes one or more floating-point registers.

In one example, the unit of register data comprises integer data from one or more integer registers.

In one example, the method of intercepting the unit of register data includes monitoring a set of register file load ports and intercepting incoming transaction data from the set of register file load ports.

In one example, the method of sorting the unit of register data into the FIFO queue includes adding the unit of register data to an end of the FIFO queue, and/or processing a previous unit of register data from a head of the FIFO queue.

In one example, the method of selecting the port of the register file includes selecting a preferred write port of the register file and/or selecting an alternative port of the register file with a lower priority than the preferred write port. In this example, selecting the preferred write port of the register file includes selecting the preferred write port to send the unit of register data to the register file based on detecting no possible collision with existing data traffic at a data pipeline of the preferred write port. Additionally or alternatively, selecting the preferred write port of the register file includes selecting the preferred write port to send the unit of register data to the register file based on detecting possible collisions with the existing data traffic at each data pipeline of each write port in a set of write ports of the register file and determining that a duration of the unit of register data in the FIFO queue exceeds a predetermined limit. In this example, the predetermined limit includes a depth of the FIFO queue, wherein the depth is calculated based on a longest latency of the preferred write port, and/or a preset time limit to force a timeout of the unit of register data. In a non-limiting example, the disclosed method further includes determining that the duration of the unit of register data in the FIFO queue does not exceed the predetermined limit and performing an additional review of the existing data pipelines to the register file during a clock cycle of the scheduler. In the above example, selecting the alternative port of the register file includes detecting a possible collision with existing data traffic at the data pipeline of the preferred write port, identifying an available port with a next highest priority, detecting no possible collision at a data pipeline of the available port, and selecting the available port based on the next highest priority and detecting no possible collision at the data pipeline of the available port.

In one example, the method of injecting the unit of register data into the data pipeline of the selected port includes sending the unit of register data to the selected port through the data pipeline, wherein the data pipeline is available. Additionally or alternatively, the method of injecting the unit of register data into the data pipeline of the selected port includes holding existing data traffic at the data pipeline, wherein the data pipeline is unavailable, and injecting the unit of register data to bypass the existing data traffic. In this example, injecting the unit of register data to bypass the existing data traffic includes bypassing the existing data traffic from the selected port during a floating-point writeback process and/or bypassing the existing data traffic from the selected port during a floating-point write pre-decode process. In a non-limiting example, the method of injecting the unit of register data into the data pipeline includes multiplexing the register data with the existing data traffic during the floating-point write pre-decode process. In non-limiting examples, the term “multiplexing” refers to a process of combining multiple input signals to an output signal.

In one implementation, an integrated circuit for integer-to-floating-point data transfers includes a register file, a FIFO queue electronically connected to a set of data pipelines to a set of write ports of the register file, and a scheduler electronically connected to the FIFO queue. In this example, the scheduler is configured to intercept a unit of register data from an external computing resource, sort the unit of register data into the FIFO queue, select a port of the register file based on a review of the set of data pipelines to the register file, and inject the unit of register data into a data pipeline of the selected port, wherein the unit of register data is held in the FIFO queue until previous register data is processed.

In one example, the unit of register data includes an integer-to-floating-point data transaction.

In one example, the scheduler is electronically connected to the set of data pipelines to the register file such that the scheduler intercepts the unit of register data from the set of data pipelines.

In one example, the integrated circuit further includes a multiplexer that injects the unit of register data into the data pipeline by multiplexing the unit of register data with existing data traffic of the data pipeline during a floating-point write pre-decode process.

In one implementation, a system for integer-to-floating-point data transfers includes at least one computing resource and an integrated circuit connected to the at least one computing resource by at least one bus. In this implementation, the integrated circuit includes a register file, a buffer electronically connected to a set of buses to a set of write ports of the register file and comprising a FIFO queue, and a scheduler of the register file electronically connected to the buffer. In this implementation, the scheduler is configured to intercept a unit of register data from the at least one computing resource, sort the unit of register data into the FIFO queue, select a port of the register file based on a review of the set of buses to the set of write ports of the register file, and inject the unit of register data into a bus of the selected port, wherein the unit of register data is held in the buffer until previous register data is processed.

In one example, the at least one computing resource shares the set of write ports with at least one alternate computing resource such that the at least one computing resource is electronically connected to the set of write ports and the at least one alternate computing resource is connected to the set of write ports.

In one example, the system further includes at least one resource scheduler of the at least one computing resource, wherein the scheduler of the register file is not electronically connected to the at least one resource scheduler.

Features from any of the implementations described herein can be used in combination with one another in accordance with the general principles described herein. These and other implementations, features, and advantages will be more fully understood upon reading the following detailed description in conjunction with the accompanying drawings and claims.

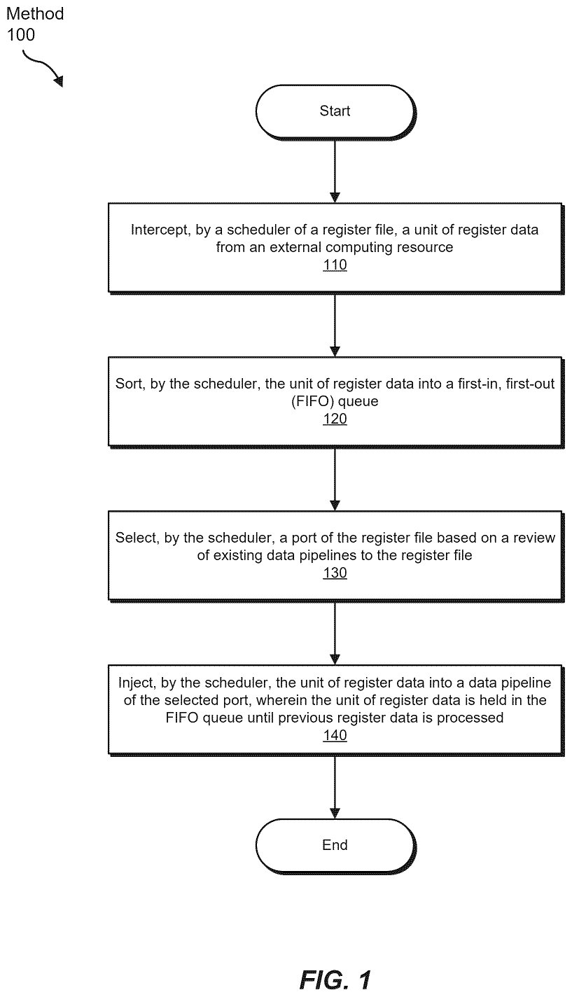

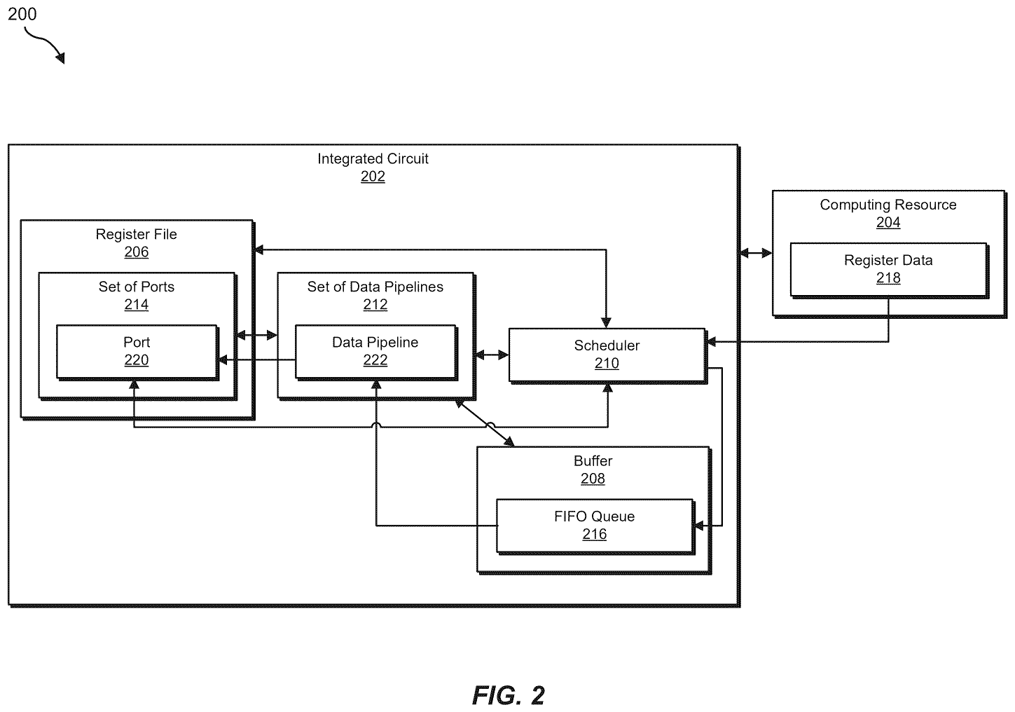

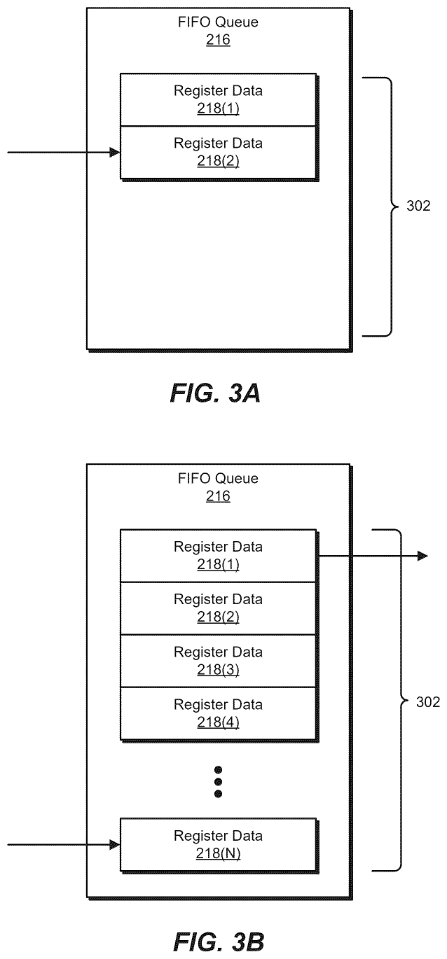

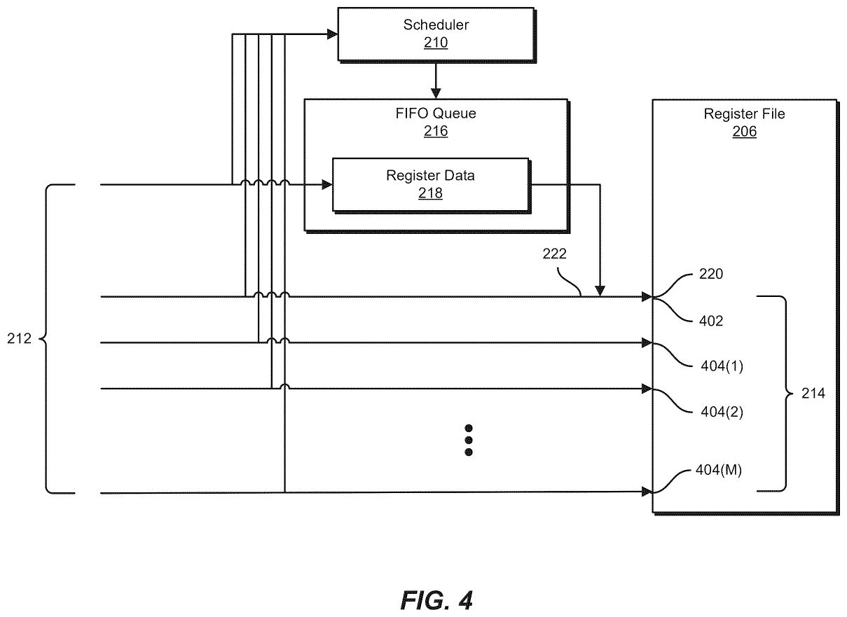

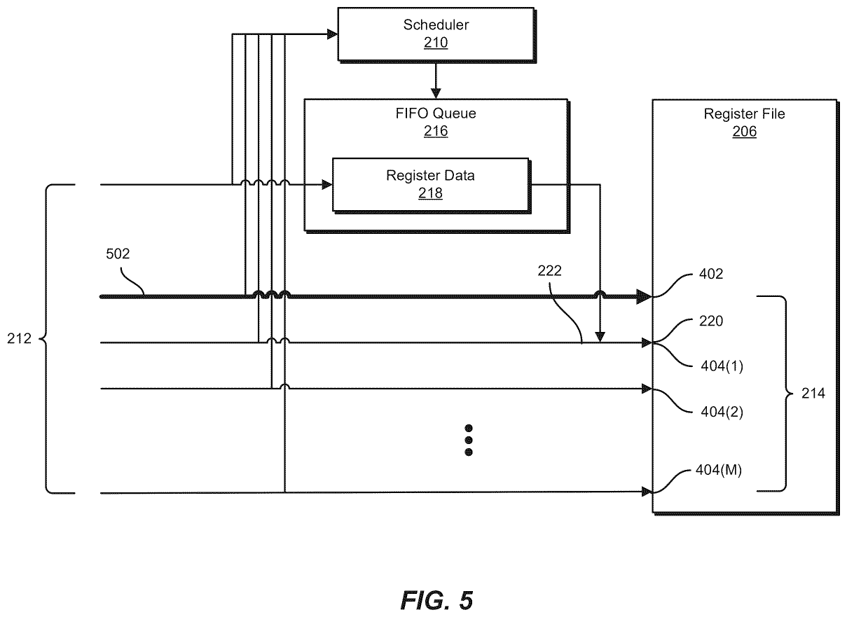

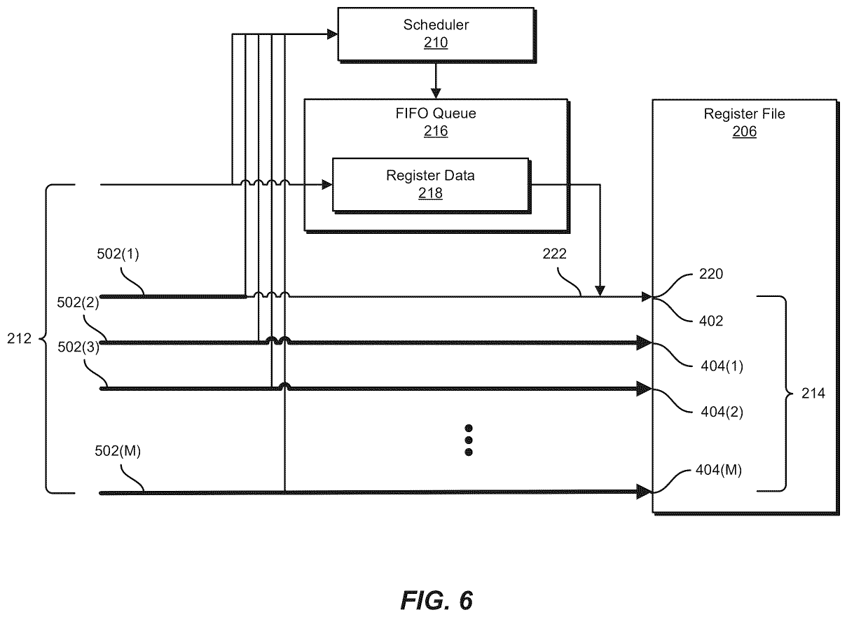

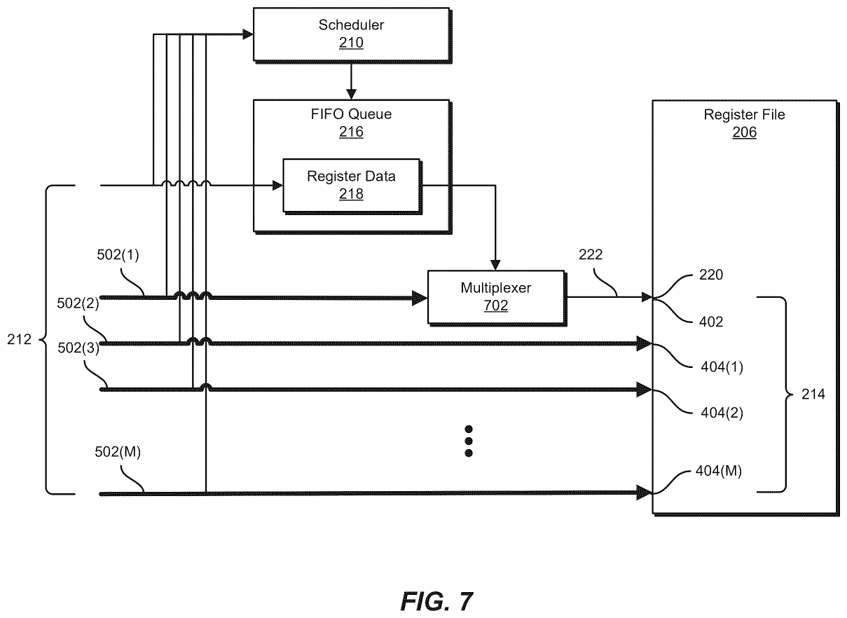

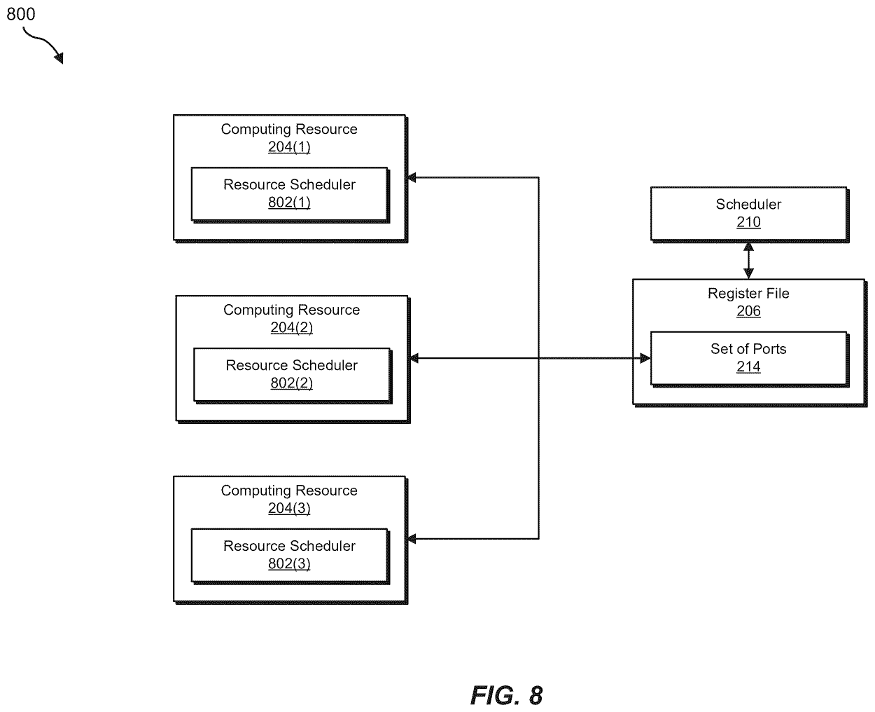

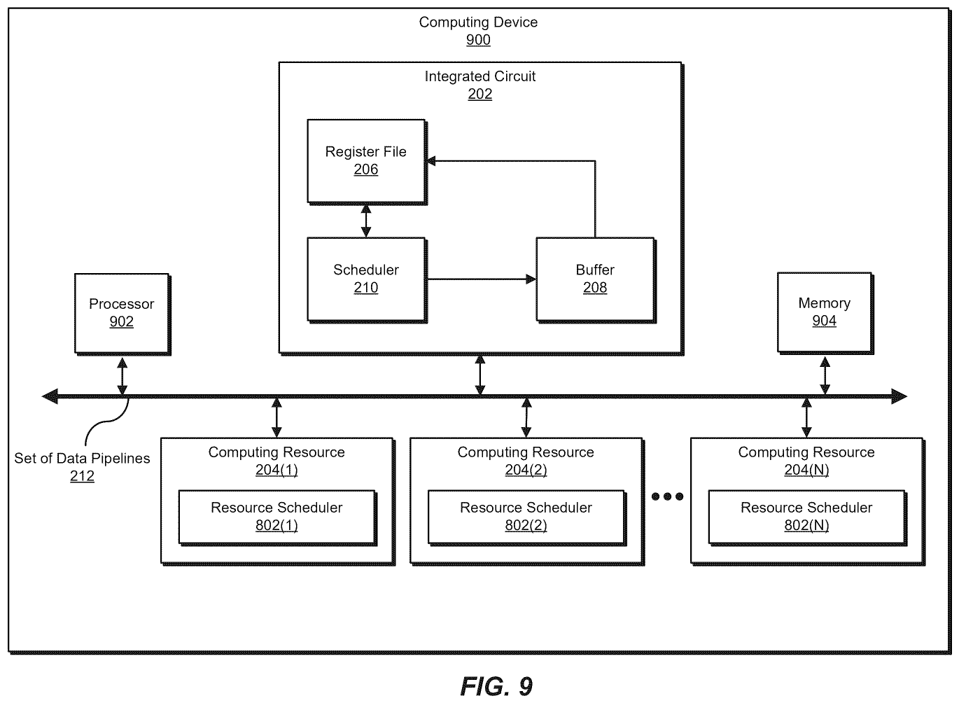

The following will provide, with reference to FIG. 1, detailed descriptions of a computer-implemented method for integer-to-floating-point data transfers. Detailed descriptions of a corresponding system will also be provided in connection with FIG. 2. In addition, detailed descriptions of an exemplary first-in, first-out queue will be provided in connection with FIGS. 3A-3B. Furthermore, detailed descriptions of exemplary port selections will be provided in connection with FIGS. 4-5. Additionally, detailed descriptions of exemplary injections of register data will be provided in connection with FIGS. 6-7. Finally, detailed descriptions of exemplary system architectures with multiple exemplary computing resources will be provided in connection with FIGS. 8-9.

FIG. 1 is a flow diagram of an example computer-implemented method 100 for integer-to-floating-point data transfers. The steps shown in FIG. 1 can be performed by any suitable computer-executable code and/or computing system, including system 200 in FIG. 2, system 800 in FIG. 8, computing device 900 in FIG. 9, and/or variations or combinations of one or more of the same. In one example, each of the steps shown in FIG. 1 can represent an algorithm whose structure includes and/or is represented by multiple sub-steps, examples of which will be provided in greater detail below.

As illustrated in FIG. 1, at step 110 one or more of the systems described herein can intercept, by a scheduler of a register file, a unit of register data from an external computing resource. For example, a scheduler 210 of a register file 206 of a system 200 in FIG. 2 intercepts register data 218 from a computing resource 204.

Step 110 can be performed in a variety of ways. As shown in FIG. 2, system 200 includes an integrated circuit 202 that includes register file 206 and scheduler 210. In a non-limiting example, system 200 includes at least one computing resource, such as computing resource 204. In this non-limiting example, integrated circuit 202 is connected to computing resource 204 by a bus, and computing resource 204 sends register data 218 to register file 206 via the bus. In some examples, integrated circuit 202 and/or computing resource 204 represent any type or form of computing device capable of reading computer-executable instructions.

In non-limiting examples, the terms “device” or “computing device” refer to any form of computing equipment capable of storing, receiving, and/or transmitting data. In these non-limiting examples, the term “integrated circuit” refers to a device, a silicon chip, a chipset, a central processing unit, and/or a computing component capable of storing and managing register files. In non-limiting examples, the term “bus” refers to a data bus capable of transmitting data between devices and/or computing components.

In some examples, system 200 represents a computing device, a processor, and/or any other suitable computing system or device with a bus. Additional examples of computing devices include, without limitation, laptops, tablets, desktops, servers, cellular phones, Personal Digital Assistants (PDAs), multimedia players, embedded systems, wearable devices (e.g., smart watches, smart glasses, etc.), smart vehicles, so-called Internet-of-Things devices (e.g., smart appliances, etc.), gaming consoles, variations or combinations of one or more of the same, or any other suitable computing device.

In some examples, system 200, integrated circuit 202, and/or computing resource 204 can include a processor that implements method 100. In a non-limiting example, integrated circuit 202 can represent a processor. In one example, the term “processor” refers to any type or form of hardware-implemented processing unit capable of interpreting and/or executing computer-readable instructions. Examples of processors include, without limitation, microprocessors, microcontrollers, Central Processing Units (CPUs), Graphical Processing Units (GPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Many other devices or subsystems can be connected to system 200 in FIG. 2, system 800 in FIG. 8, and/or computing device 900 in FIG. 9. Conversely, all of the components and devices illustrated in FIG. 2, FIG. 8, and/or FIG. 9 need not be present to practice the implementations described and/or illustrated herein. The devices and subsystems referenced above can also be interconnected in different ways from that shown in FIG. 2, FIG. 8, and FIG. 9. System 200, system 800, and/or computing device 900 can also employ any number of software, firmware, and/or hardware configurations. For example, one or more of the example implementations disclosed herein can be encoded as a computer program (also referred to as computer software, software applications, computer-readable instructions, and/or computer control logic) on a computer-readable medium.

The term “computer-readable medium,” in some non-limiting examples, refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

In non-limiting examples, the term “scheduler” refers to a software or hardware component, such as a circuit configured to be a decider, that schedules processes and data. In non-limiting examples, the terms “register” and “processor register” refer to a software or hardware component configured to store data and that can be quickly accessed by a processor, such as a central processing unit. In these examples, the term “register file” refers to an array of registers or processor registers, often defined within a central processing unit. In some examples, register file 206 represents a physical register file as part of a hardware component or circuit. In other examples, register file 206 can represent a virtual or software component.

In a non-limiting example, and register file 206 can include one or more floating-point registers, such as an array of registers that stores and processes floating-point numbers. In a non-limiting example, computing resource 204 can represent or include one or more integer registers, which handle integer numbers. In this example, register data 218 represents integer data from an integer register. In this example, register file 206 and/or integrated circuit 202 can transform register data 218 from an integer to a floating-point number before writing it to a register in register file 206.

As illustrated in the non-limiting example of FIG. 2, scheduler 210 intercepts register data 218 by monitoring a set of register file load ports, such as a set of ports 214, to register file 206 and intercepting incoming transaction data from the set of register file load ports. In non-limiting examples, the term “port” refers to a connection point to perform input, output, and/or other operations for a software or hardware component. Examples of ports include, without limitation, read ports, write ports, load ports, ports used for multiple functions and/or any other suitable interface for handling data. In the example of FIG. 2, set of ports 214 can include a multitude of similar or different ports, including read/write ports that can handle incoming or outgoing transaction data. In some examples, a single unit of register data, such as register data 218, can include an integer-to-floating-point data transaction. In this example, an integer register of computing resource 204 can sent the integer-to-floating-point data transaction to a floating-point register of register file 206.

In one example, scheduler 210 is electronically connected to a set of data pipelines 212 to register file 206 such that scheduler 210 intercepts register data 218 from set of data pipelines 212. In the example of FIG. 4, scheduler 210 monitors all pipelines in set of data pipelines 212 that lead to set of ports 214 of register file 206. In one non-limiting example, scheduler 210 is capable of intercepting all incoming transaction data from all data pipelines of set of data pipelines 212. In some examples, scheduler 210 and/or a different computing component connected to scheduler 210 can act as a load buffer for register file 206.

Returning to FIG. 1, at step 120 one or more of the systems described herein can sort, by the scheduler, the unit of register data into a FIFO queue. For example, scheduler 210 in FIG. 2 sorts register data 218 into a FIFO queue 216.

Step 120 can be performed in a variety of ways. In some implementations, FIFO queue 216 is electronically connected to set of data pipelines 212 to set of ports 214 of register file 206. In these implementations, scheduler 210 is electronically connected to FIFO queue 216. In the example of FIG. 2, integrated circuit 202 includes a buffer 208 that is electronically connected to a set of buses, such as set of data pipelines 212, to a set of write ports, such as set of ports 214, of register file 206. In this example, buffer 208 can include FIFO queue 216. Additionally, in this example, scheduler 210 is electronically connected to buffer 208. In other examples, FIFO queue 216 can represent a buffer sorted in FIFO order. In non-limiting examples, the terms “first-in, first-out” or “FIFO” refer to a method of managing data by ensuring the oldest data is processed first. In non-limiting examples, the term “buffer” refers to temporary storage that holds data during transition from one location to another.

In one example, scheduler 210 sorts register data 218 into FIFO queue 216 by adding register data 218 to an end of FIFO queue 216. In one example, scheduler 210 can then process a previous unit of register data from a head of FIFO queue 216. As illustrated in FIG. 3A, scheduler 210 can sort register data 218(2) into FIFO queue 216, which can contain previously added register data 218(1). In this example, register data 218(1) at the head of FIFO queue 216 is the next unit of data to be processed. As illustrated in FIG. 3B, FIFO queue 216 can include multiple units of register data, up to register data 218(N), with register data 218(1) representing the oldest unit of register data and register data 218(N) representing the most recently intercepted unit of register data.

Returning to FIG. 1, at step 130 one or more of the systems described herein can select, by the scheduler, a port of the register file based on a review of existing data pipelines to the register file. For example, scheduler 210 in FIG. 2 selects a port 220 of register file 206 based on a review of set of data pipelines 212 to register file 206.

Step 130 can be performed in a variety of ways. In non-limiting examples, the terms “pipeline” and “data pipeline” refer to a series of steps to process data, leading from one output to the next input. In these examples, a data pipeline can include a bus that transfers data between computing components. In the example of FIG. 2, set of data pipelines 212 can include buses leading from computing resource 204 to register file 206 of integrated circuit 202.

In one implementation, scheduler 210 selects port 220 by selecting a preferred write port of register file 206. For example, the preferred write port of register file 206 can be a predetermined port assigned by system 200 or a manually selected port. In this implementation, scheduler 210 selects the preferred write port as port 220 to send register data 218 to register file 206 based on detecting no possible collision with existing data traffic at a data pipeline 222 of the preferred write port. In non-limiting examples, the term “collision” generally refers to the conflict between existing data traffic in a pipeline and an attempt to inject additional data to the pipeline. In this implementation, scheduler 210 monitors data pipeline 222, which leads to port 220, to determine no data collision will occur if register data 218 is sent to port 220. In other words, scheduler 210 can review a set of buses to the set of write ports of register file 206 to determine which buses and ports are currently being used. If a preferred port is currently available, with no data being transferred to the port, scheduler 210 selects the preferred port to send the next unit of register data from FIFO queue 216 to the preferred port.

FIG. 4 illustrates an exemplary selection of a preferred write port 402 as port 220. In the example of FIG. 4, scheduler 210 intercepts register data 218 and adds it to FIFO queue 216. In this example, scheduler 210 monitors each pipeline in set of data pipelines 212 and each port in set of ports 214. In this example, scheduler 210 then detects that data pipeline 222 connected to preferred write port 402 is not in use. Because data pipeline 222 is not in use, scheduler 210 can select preferred write port 402 as selected port 220 and send register data 218 from FIFO queue 216 to preferred write port 402 via data pipeline 222.

In one implementation, scheduler 210 can select port 220 by selecting an alternative port of register file 206 with a lower priority than the preferred write port. In this implementation, scheduler 210 can select the alternative port by detecting a possible collision with existing data traffic at the data pipeline of preferred write port 402, identifying an available port with a next highest priority, detecting no possible collision at a data pipeline of the available port, and selecting the available port based on the next highest priority and detecting no possible collision at the data pipeline of the available port. In other words, if a preferred port is unavailable, scheduler 210 can look for and select an alternative port that is available, such as by checking load ports for potential alternative write ports to steal. For example, scheduler 210 can check a status of ports based on a predetermined priority order, which can be assigned by system 200 or manually assigned. The priority of ports can be determined by performance metrics or any arbitrary ordering scheme. By checking load ports, scheduler 210 can detect potential collisions early enough to avoid them.

FIG. 5 illustrates an exemplary selection of an alternative port 404(1) instead of preferred write port 402. In this example, set of ports 214 can include preferred write port 402 and alternative ports 404(1)-(M). In this example, scheduler 210 can review the status of each of alternative ports 404(1)-(M) in a predetermined priority order. For example, after detecting existing data traffic 502 heading to preferred write port 402, scheduler 210 can determine that injecting register data 218 into the same data pipeline can cause a collision with existing data traffic 502. In this example, scheduler 210 can then review alternative port 404(1) as the next highest priority port to determine whether there is any existing data traffic that can cause a collision. After detecting no additional data traffic, scheduler 210 can inject register data 218 into data pipeline 222 heading to alternative port 404(1).

In one implementation, scheduler 210 selects preferred write port 402 by selecting preferred write port 402 based on detecting possible collisions with the existing data traffic at each data pipeline of each write port in set of ports 214 and then determining that a duration of register data 218 in FIFO queue 216 exceeds a predetermined limit. In other words, if scheduler 210 detects existing data traffic in all data pipelines for set of ports 214 and also determines that register data 218 has been in FIFO queue 216 long enough, scheduler 210 automatically selects preferred write port 402 as port 220.

In some implementations, the predetermined limit includes a depth of FIFO queue 216. In these implementations, the depth of FIFO queue 216 is calculated based on a longest latency of preferred write port 402. In these implementations, the depth of FIFO queue 216 can be adjusted based on the latency of preferred write port 402 to ensure FIFO queue 216 does not overfill while scheduler 210 searches for an available port. In other words, additional register data can continue to be added to FIFO queue 216 while the oldest register data is injected into a data pipeline, and the depth of FIFO queue 216 is at least enough to ensure no data is dropped during this process. Additionally or alternatively, the predetermined limit includes a preset time limit to force a timeout of register data 218. In these implementations, register data 218 can time out after a certain amount of time from the time computing resource 204 first sends register data 218 toward register file 206. In these implementations, scheduler 210 can tracking an amount of time that register data 218 has been in FIFO queue 216 and inject register data 218 into a pipeline if a time limit is reached. For example, as illustrated in FIG. 3A, a depth 302 of FIFO queue 216 is not filled with only register data 218(1) and register data 218(2). In contrast, as illustrated in FIG. 3B, register data 218(1)-(N) fills the limit of depth 302 of FIFO queue 216. In this example, scheduler 210 can automatically select preferred write port 402 to inject register data 218(1) to ensure FIFO queue 216 is not overfilled if additional register data arrives.

In some examples, scheduler 210 can determine that the duration of register data 218 in FIFO queue 216 does not exceed the predetermined limit and, subsequently, can perform an additional review of the existing data pipelines to register file 206 during a clock cycle of scheduler 210. For example, as illustrated in FIG. 3A, scheduler 210 can continue to search for an available port during additional clock cycles while register data 218(1) has not exceeded a limit of FIFO queue 216. In the example of FIG. 5, scheduler 210 selects alternative port 404(1) after determining existing data traffic 502 will cause a collision. However, if register data 218(1) does not exceed the predetermined limit and FIFO queue 216 is not at risk of being overfilled, scheduler 210 can continue to wait for preferred write port 402 to

### Become Available.

FIG. 6 illustrates an exemplary injection of register data 218 into data pipeline 222 for preferred write port 402. In this example, each pipeline in set of data pipelines 212 has existing data traffic 502(1)-(M). In this example, scheduler 210 can detect that FIFO queue 216 is reaching a limit and that register data 218 must immediately be injected into a pipeline. In this example, scheduler 210 can then select preferred write port 402 as port 220 and inject register data 218 into data pipeline 222 to avoid overfilling FIFO queue 216.

Returning to FIG. 1, at step 140 one or more of the systems described herein can inject, by the scheduler, the unit of register data into a data pipeline of the selected port, wherein the unit of register data is held in the FIFO queue until previous register data is processed. For example, scheduler 210 in FIG. 2 injects register data 218 into data pipeline 222 of port 220 after holding register data 218 in FIFO queue 216 until previous register data is processed.

Step 140 can be performed in a variety of ways. In the example of FIG. 2, register data 218 can be held in buffer 208 while previously intercepted register data is processed. In other words, data from FIFO queue 216 is processed in order until register data 218 is the head of FIFO queue 216. In this example, scheduler 210 can then inject register data 218 into a bus connected to port 220.

In some implementations, scheduler 210 injects register data 218 by sending register data 218 to port 220 through data pipeline 222, wherein data pipeline 222 is available. In the example of FIG. 4, scheduler 210 detects no traffic in data pipeline 222 and injects register data 218 directly into data pipeline 222 toward preferred write port 402. Similarly, in the example of FIG. 5, scheduler 210 selects alternative port 404(1) while available and injects register data 218 into different data pipeline 222 toward alternative port 404(1).

In some implementations, scheduler 210 injects register data 218 by holding existing data traffic at data pipeline 222, wherein data pipeline 222 is unavailable, and then injecting register data 218 to bypass the existing data traffic. In other words, scheduler 210 prevents the existing data traffic of data pipeline 222 from being processed until register data 218 is processed and received by port 220. In these implementations, injecting register data 218 to bypass the existing data traffic can include bypassing the existing data traffic from port 220 during a floating-point writeback process and/or during a floating-point write pre-decode process. In non-limiting examples, the term “writeback process” refers to an operation to write data to permanent storage, such as a register file, after having read the data into a cache or temporary storage. In non-limiting example, the term “write pre-decode process” refers to an operation to begin decoding or translating instructions for writing data. In some examples, scheduler 210 bypasses data from a load port during floating-point writeback processes. In some examples, scheduler 210 bypasses a pipeline of preferred write port 402 either during floating-point writeback processes or during floating-point write pre-decode processes, which occur before floating-point writeback. Because integer-to-floating-point data transactions can be written to different ports, scheduler 210 can bypass existing data during the relevant clock cycles based on the port. In the example of FIG. 6, scheduler 210 can hold existing data traffic 502(1) to first inject register data 218 into data pipeline 222.

In some implementations, scheduler 210 can inject register data 218 into data pipeline 222 by multiplexing register data 218 with the existing data traffic during the floating-point write pre-decode process. In these implementations, integrated circuit 202 can include a multiplexer that multiplexes register data 218 with the existing data traffic. For example, FIG. 7 illustrates a multiplexer 702 that multiplexes register data 218 with existing data traffic 502(1) such that both are transmitted to preferred write port 402.

In some examples, the disclosed systems include computing resource 204 that shares set of ports 214 with at least one alternate computing resource such that computing resource 204 is electronically connected to set of ports 214 and the at least one alternate computing resource is also connected to set of ports 214. In some examples, scheduler 210 is not electronically connected to a resource scheduler of computing resource 204. In the example of FIG. 8, system 800 includes computing resources 204(1)-(3) that share set of ports 214 of register file 206. In this example, each of computing resources 204(1)-(3) includes resource schedulers 802(1)-(3), respectively. In this example, resource schedulers 802(1)-(3) manage computing resources 204(1)-(3) separately from scheduler 210 and do not communicate directly. In these examples, external computing resources share a pool of write ports, and each can potentially steal from another data pipeline to ensure data transfers are completed. Additionally, scheduler 210 can combine loads and data transfers from multiple computing resources, such as through multiplexing. Further, although described as handling integer-to-floating-point data transactions, the disclosed systems and methods can alternatively handle other types of data transactions, such as floating-point-to-integer data transfers.

In some implementations, as illustrated in the example of FIG. 9, a computing device 900 can include integrated circuit 202 in connection with set of data pipelines 212. In this example, computing resources 204(1)-(N) are also connected to set of data pipelines 212, with each of computing resources 204(1)-(N) managed by resource schedulers 802(1)-(N), respectively. In this example, integrated circuit 202 is managed by scheduler 210, which receives data from set of data pipelines 212 and uses buffer 208 to schedule data to be sent to register file 206. Additionally, in this example, computing device 900 includes at least one separate processor 902, which can include additional integrated circuits or other physical processors. In this example, computing device 900 includes a memory 904, which can include a memory device or database for storing other data. In further examples, computing device 900 can include additional integrated circuits for managing register data for additional register files. In these examples, computing device 900 can also include additional sets of data pipelines connected to ports of the additional register files.

As described above, the disclosed systems and methods manage integer-to-floating-point data transfers from an external resource to a register file. The implementations and systems described herein first intercept incoming transaction data to the register file, such as by monitoring a set of data pipelines to a set of load and/or write ports of the register file. The disclosed method also stores incoming data transfers into a FIFO queue to process them in order. The method then reviews the monitored data pipelines to determine if there would be a collision by injecting register data from the FIFO queue into a pipeline. Additionally, the method can prioritize certain ports and select alternatives with the preferred port is not available, thereby enabling opportunistic use of other ports before resorting to forcing data into a pipeline. Furthermore, if no pipelines are opportunistically available, the method can jam a preferred pipeline and inject data from the FIFO queue into the pipeline. By reviewing each possible port in turn, the disclosed systems and methods can reduce the number of dedicated write ports needed for a register file while still ensuring the data reaches the register file. Thus, the disclosed systems and methods can handle integer-to-floating-point data transfers without costly architecture.

While the foregoing disclosure sets forth various implementations using specific block diagrams, flowcharts, and examples, each block diagram component, flowchart step, operation, and/or component described and/or illustrated herein can be implemented, individually and/or collectively, using a wide range of hardware, software, or firmware (or any combination thereof) configurations. In addition, any disclosure of components contained within other components should be considered example in nature since many other architectures can be implemented to achieve the same functionality.

In some examples, all or a portion of example system 200 in FIG. 2, system 800 in FIG. 8, and/or computing device 900 in FIG. 9 can represent portions of a cloud-computing or network-based environment. Cloud-computing environments can provide various services and applications via the Internet. These cloud-based services (e.g., software as a service, platform as a service, infrastructure as a service, etc.) can be accessible through a web browser or other remote interface. Various functions described herein can be provided through a remote desktop environment or any other cloud-based computing environment.

In some examples, all or a portion of example system 200 in FIG. 2, system 800 in FIG. 8, and/or computing device 900 in FIG. 9 can represent portions of a mobile computing environment. Mobile computing environments can be implemented by a wide range of mobile computing devices, including mobile phones, tablet computers, e-book readers, personal digital assistants, wearable computing devices (e.g., computing devices with a head-mounted display, smartwatches, etc.), variations or combinations of one or more of the same, or any other suitable mobile computing devices. In some examples, mobile computing environments can have one or more distinct features, including, for example, reliance on battery power, presenting only one foreground application at any given time, remote management features, touchscreen features, location and movement data (e.g., provided by Global Positioning Systems, gyroscopes, accelerometers, etc.), restricted platforms that restrict modifications to system-level configurations and/or that limit the ability of third-party software to inspect the behavior of other applications, controls to restrict the installation of applications (e.g., to only originate from approved application stores), etc. Various functions described herein can be provided for a mobile computing environment and/or can interact with a mobile computing environment.

The process parameters and sequence of steps described and/or illustrated herein are given by way of example only and can be varied as desired. For example, while the steps illustrated and/or described herein can be shown or discussed in a particular order, these steps do not necessarily need to be performed in the order illustrated or discussed. The various example methods described and/or illustrated herein can also omit one or more of the steps described or illustrated herein or include additional steps in addition to those disclosed.

While various implementations have been described and/or illustrated herein in the context of fully functional computing systems, one or more of these example implementations can be distributed as a program product in a variety of forms, regardless of the particular type of computer-readable media used to actually carry out the distribution. The implementations disclosed herein can also be implemented using modules that perform certain tasks. These modules can include script, batch, or other executable files that can be stored on a computer-readable storage medium or in a computing system. In some implementations, these modules can configure a computing system to perform one or more of the example implementations disclosed herein.

The preceding description has been provided to enable others skilled in the art to best utilize various aspects of the example implementations disclosed herein. This example description is not intended to be exhaustive or to be limited to any precise form disclosed. Many modifications and variations are possible without departing from the spirit and scope of the present disclosure. The implementations disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method comprising:
intercepting, by a scheduler of a register file, a unit of register data from an external computing resource;
sorting, by the scheduler, the unit of register data into a first-in, first-out (FIFO) queue;
selecting, by the scheduler, a port of the register file based on a review of existing data pipelines to the register file; and
injecting, by the scheduler, the unit of register data into a data pipeline of the selected port, wherein the unit of register data is held in the FIFO queue until previous register data is processed.

2. The method of claim 1, wherein the register file comprises at least one floating-point register.

3. The method of claim 1, wherein the unit of register data comprises integer data from at least one integer register.

4. The method of claim 1, wherein intercepting the unit of register data comprises:
monitoring a set of register file load ports; and
intercepting incoming transaction data from the set of register file load ports.

5. The method of claim 1, wherein sorting the unit of register data into the FIFO queue comprises at least one of:
adding the unit of register data to an end of the FIFO queue; and
processing a previous unit of register data from a head of the FIFO queue.

6. The method of claim 1, wherein selecting the port of the register file comprises at least one of:
selecting a preferred write port of the register file; and
selecting an alternative port of the register file with a lower priority than the preferred write port.

7. The method of claim 6, wherein selecting the preferred write port of the register file comprises at least one of:
selecting the preferred write port to send the unit of register data to the register file based on detecting no possible collision with existing data traffic at a data pipeline of the preferred write port; and
selecting the preferred write port to send the unit of register data to the register file based on:
detecting possible collisions with the existing data traffic at each data pipeline of each write port in a set of write ports of the register file; and
determining that a duration of the unit of register data in the FIFO queue exceeds a predetermined limit.

8. The method of claim 7, wherein the predetermined limit comprises at least one of:
a depth of the FIFO queue, wherein the depth is calculated based on a longest latency of the preferred write port; and
a preset time limit to force a timeout of the unit of register data.

9. The method of claim 7, further comprising:
determining that the duration of the unit of register data in the FIFO queue does not exceed the predetermined limit; and
performing an additional review of the existing data pipelines to the register file during a clock cycle of the scheduler.

10. The method of claim 6, wherein selecting the alternative port of the register file comprises:
detecting a possible collision with existing data traffic at the data pipeline of the preferred write port;
identifying an available port with a next highest priority;
detecting no possible collision at a data pipeline of the available port; and
selecting the available port based on the next highest priority and detecting no possible collision at the data pipeline of the available port.

11. The method of claim 1, wherein injecting the unit of register data into the data pipeline of the selected port comprises at least one of:
sending the unit of register data to the selected port through the data pipeline, wherein the data pipeline is available;
holding existing data traffic at the data pipeline, wherein the data pipeline is unavailable; and
injecting the unit of register data to bypass the existing data traffic.

12. The method of claim 11, wherein injecting the unit of register data to bypass the existing data traffic comprises at least one of:
bypassing the existing data traffic from the selected port during a floating-point writeback process; and
bypassing the existing data traffic from the selected port during a floating-point write pre-decode process.

13. The method of claim 12, wherein injecting the unit of register data into the data pipeline comprises multiplexing the register data with the existing data traffic during the floating-point write pre-decode process.

14. An integrated circuit comprising:
a register file;
a first-in, first-out (FIFO) queue electronically connected to a set of data pipelines to a set of write ports of the register file; and
a scheduler electronically connected to the FIFO queue and configured to:
intercept a unit of register data from an external computing resource;
sort the unit of register data into the FIFO queue;
select a port of the register file based on a review of the set of data pipelines to the register file; and
inject the unit of register data into a data pipeline of the selected port, wherein the unit of register data is held in the FIFO queue until previous register data is processed.

15. The integrated circuit of claim 14, wherein the unit of register data comprises an integer-to-floating-point data transaction.

16. The integrated circuit of claim 14, wherein the scheduler is electronically connected to the set of data pipelines to the register file such that the scheduler intercepts the unit of register data from the set of data pipelines.

17. The integrated circuit of claim 14, further comprising a multiplexer that injects the unit of register data into the data pipeline by multiplexing the unit of register data with existing data traffic of the data pipeline during a floating-point write pre-decode process.

18. A system comprising:
at least one computing resource; and
an integrated circuit connected to the at least one computing resource by at least one bus, wherein the integrated circuit comprises:
a register file;
a buffer electronically connected to a set of buses to a set of write ports of the register file and comprising a first-in, first-out (FIFO) queue; and
a scheduler of the register file electronically connected to the buffer and configured to:
intercept a unit of register data from the at least one computing resource;
sort the unit of register data into the FIFO queue;
select a port of the register file based on a review of the set of buses to the set of write ports of the register file; and
inject the unit of register data into a bus of the selected port, wherein the unit of register data is held in the buffer until previous register data is processed.

19. The system of claim 18, wherein the at least one computing resource shares the set of write ports with at least one alternate computing resource such that:
the at least one computing resource is electronically connected to the set of write ports; and
the at least one alternate computing resource is connected to the set of write ports.

20. The system of claim 18, further comprising at least one resource scheduler of the at least one computing resource, wherein the scheduler of the register file is not electronically connected to the at least one resource scheduler.
